(19) United States
(12) Patent Application Publication
(10) Pub. No.: US 2002/0169893 A1
(43) Pub. Date: Nov. 14, 2002

(54) System and method for computer data synchronization

(76) Inventors: Li-Han Chen, Torrance, CA (US); Michael Lawrence Takayama, Marina del Rey, CA (US); Dominic Koman Chan, Westwood, CA (US)

Correspondence Address: O'MELVENY & MYERS LLP, 400 So. Hope Street, Los Angeles, CA, 90071-2899, US

(21) Appl. No.: 09/851,811

(22) Filed: May 9, 2001

(51) Int. Cl. G06F 15/16

(52) U.S. Cl. 709/248; 709/204

(57) ABSTRACT

A system and method is provided for synchronizing computer data such that work can be conducted from a remote location. In the preferred embodiment of the present invention, a computer data synchronization system includes a database, a server, and a synch application adapted to communicate with a plurality of reception devices through the server. More particularly, the synch application is adapted to receive synchronization data from a controlling one of the plurality of reception devices such that a portion of original computer data can be provided to the plurality of reception devices, where the portion of original computer data is based upon a synchronized portion of the original computer data that is being displayed on the controlling one of the plurality of reception devices. If the controlling one of the plurality of reception devices scrolls to a new portion of original computer data, then the synch application responds accordingly by providing the plurality of reception devices with substantially the same new portion of original computer data. The synch application may further be adapted to receive and provide annotated data, translated annotated data, communication data, and pointer icon data to the plurality of reception devices.

### BACKGROUND OF THE INVENTION

1. Field of the Invention

The present invention relates to synchronizing a plurality of reception devices such that computer data can be simultaneously shared, or more particularly, to a system and method for computer data synchronization.

2. Description of Related Art

The high cost of labor within the United States has made it financially attractive for companies to send labor-intensive work to other countries, such as China or India, where the cost of labor is significantly lower. By sending labor-intensive work overseas, a U.S. company is able to lower its overhead and compete more aggressively with US-based competition. This results in lower prices for consumers and larger profit margins for the U.S. company.

In order to maximize these results, the U.S. company may try to send 100% of the work that would ordinarily be performed in the U.S. overseas. However, the nature of the company's business, and its interaction level with its clients may dictate how much work (if any) can be sent overseas. For example, a product-based industry, such as manufacturing clothing or appliances, can easily perform work overseas. This is because the level of interaction between a product-based company and a client is minimal or non-existent. A U.S. client may not have to be consulted before a change is made to a clothing line or to an appliance design. On the other hand, a service-based industry, such as software design or media production, can rarely perform work overseas. This is because the level of interaction between a service-based company and a client is extremely high. A U.S. client usually has to be consulted before a change is made to its software design or to its media production. Thus, the cost advantages typically realized by sending work overseas may be outweighed by the time delay and communication costs associated with waiting for and gathering client feedback.

To illustrate this concept, FIG. 1 shows an exemplary production map 100 of a U.S. service-based company, such as a software designer. Initially, the U.S. service-based company includes a headquarters (HQ) 112, a local partner (LP) 114, and a client 116 located within the United States 110. They communicate with each other through a local communication channel 130, which includes electronic communication (e.g., e-mail, facsimile, telephone), in-person communication (e.g., meetings, business luncheons, client visits), and same-day mail service (e.g., commercial courier services).

Once the client 116 decides to use the company's services, the client 116 may interact with the company's HQ 112 by providing and discussing a set of design criteria (e.g., software design criteria). Although the design criteria could be sent electronically or mailed, and subsequently discussed over the telephone, it is more efficient if the parties (i.e., the client 116 and the HQ 112) meet in-person to review and discuss the criteria. The reason an in-person meeting is more effective is because both parties (i.e., the client 116 and the HQ 112) are looking at the same data and are able to express ideas through words, drawings, and by pointing to particular characteristics within the data. This meeting may be followed by a similar in-person meeting between the company's HQ 112 and the company's LP 114, which is the division that may ultimately perform the design work for the client 116. If problems or questions arise while the work is being performed, the client 116 may be contacted either via telephone or e-mail. If the problem is severe, or a first draft needs to be evaluated, the client 116 may choose to have another in-person meeting to discuss proposed solutions or changes. This process continues (e.g., electronic communication and mail service for simple problems and in-person communication for complex problems) until the design has been approved by the client 116.

In an attempt to reduce overhead, the U.S. service-based company may decide to send work to a foreign branch office (FBO) 122 in China 120, which in turn may utilize two foreign partners (FPs) 124, wherein one is in China 120 and the other is in India 150. The China-based FBO 122, China-based FP 124, and India-based FP 124 communicate through a local communication channel 130 similar to the communication channel previously discussed. Thus, if a problem or question arises while the work is being performed at the company's China-based FP 124, a telephone, e-mail, or in-person meeting can be arranged between the China-based FP 124 and the China-based FBO 122, depending upon the severity of the problem. The situation is slightly different if a problem arises that requires communication with the company's US-based HQ 112. This is because the company's China-based FBO 122 and the company's US-based HQ 112 cannot communicate over the local communication channel 130, but instead must communicate over a remote communication channel 140. The remote communication channel 140 includes electronic communication (e.g., e-mail, facsimile, telephone), in-person communication (e.g., trips from U.S. to China) and next day mail service (e.g., UPS, Fed-X, Airborne Express). The drawback of such a communication channel (i.e., the remote communication channel 140) is that problems or questions must be resolved either through E-mail or the telephone (which is ineffective), through next day mail (which is inefficient), or flying the client 116 or an employee from the US-based HQ 112 to China 120 for an in-person meeting (which is expensive).

Thus, a need exists to have a system for providing synchronized communication between a plurality of reception devices located in different locations such that a plurality of users operating these reception devices can simulate an in-person meeting by simultaneously viewing original computer data and corresponding annotated data.

### SUMMARY OF THE INVENTION

The present invention provides a system and method for synchronizing computer data such that work can be conducted from a remote location. A computer data synchronization system of the present invention includes a database, a server, and a synch application adapted to communicate with a plurality of reception devices through the server. More particularly, the synch application is adapted to receive synchronization data from a controlling one of the plurality of reception devices such that a portion of original computer data can be provided to the plurality of reception devices. The portion of original computer data that is provided to the plurality of reception devices is based upon a synchronized portion of the original computer data that is being displayed on the controlling one of the plurality of reception devices. Such a system allows each one of the plurality of reception devices to display substantially the same portion of original computer data at the same time. If the controlling reception device scrolls to a new portion of original computer data, then the synch application responds accordingly by providing the plurality of reception devices with substantially the same new portion of original computer data. The synchronization data may further include pointer icon data to enable the plurality of reception devices to see the controlling reception device's pointer icon as it is moved over the original computer data.

The synch application may further be adapted to receive annotated data from the controlling reception device such that the annotated data can be superimposed over the portion of original computer data that is being provided to the plurality of reception devices. The annotated data may include, but is not limited to, text data, graphic data, application program data, hyperlink data, video data, and audio data. This allows the controlling reception device to share the original computer data in a marked-up fashion with the plurality of reception devices. The synchronization system may further provide the plurality of reception devices with additional annotated data, that identifies how and/or when corresponding annotated data was added, created, or deleted, and a synch button, that enables any synchronized reception device to become the controlling reception device. Through the use of a locking application, this annotated data can be retrieved at any later time and viewed in its original context regardless of the window size of the browser application that is being used to view the data.

To enhance communication, the synch application may further be adapted to receive communication data from any one of the plurality of reception devices, and provide communication data to the plurality of reception devices. The communication data, which may include, but is not limited to, text data, graphic data, program application data, hyperlink data, video data, and audio data, is provided to the plurality of reception devices such that it can be displayed in a communication window. The synch application may further include a language translation application that is adapted to translate annotated data and/or communication data into at least one other textual or graphical language.

A more complete understanding of the system and method for synchronizing computer data will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram showing an exemplary production map of a U.S. service-based company distributing work loads throughout the U.S., China, and India.

FIG. 2 is a physical layer diagram illustrating a computer data synchronization system operating in accordance with one embodiment of the present invention.

FIG. 3 is a communication layer diagram illustrating a computer data synchronization system operating in accordance with one embodiment of the present invention.

FIG. 4 is a flow chart illustrating one embodiment of the language translation application of the present invention.

FIG. 5 is a flow chart illustrating another embodiment of the language translation application of the present invention.

FIG. 6 is a block diagram illustrating how a first reception device initiates a new synchronization session.

FIG. 7 is a block diagram illustrating how a second reception device joins an existing synchronization session.

FIG. 8 is a block diagram illustrating data synchronization between a plurality of reception devices, where data is received from one reception device, logged, and provided to at least one other reception device.

FIG. 9 is a block diagram illustrating how data may be generated by one reception device.

FIG. 10 is a block diagram illustrating how data may be received by at least one other reception device.

FIG. 11 is an exemplary screen shot from a reception device operating in accordance with the computer data synchronization system of the present invention.

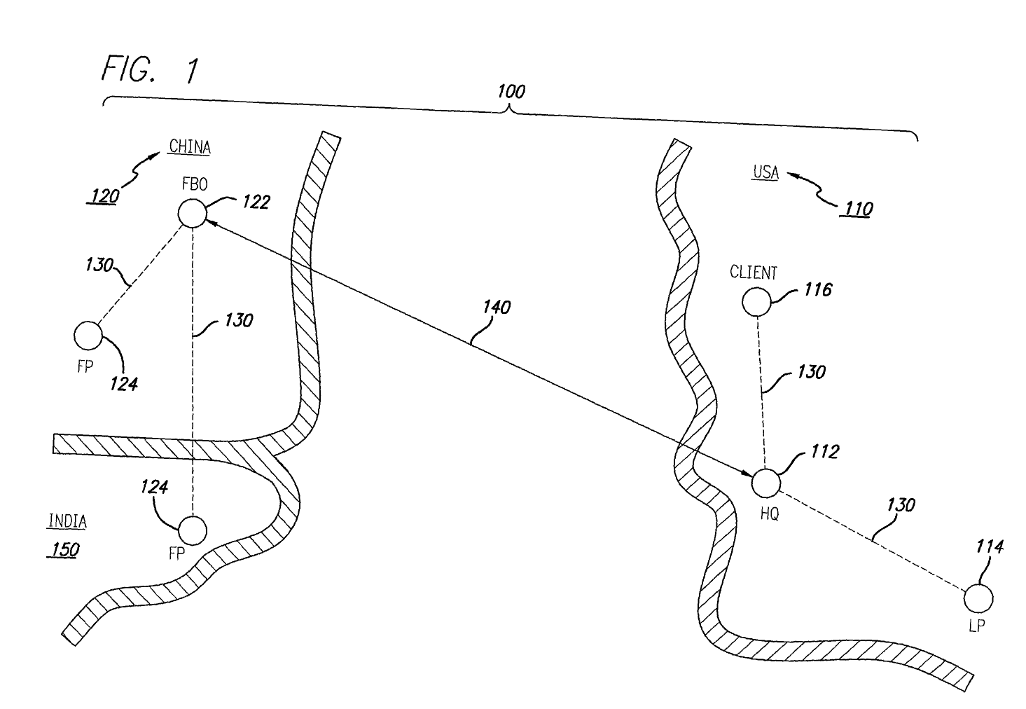

### DETAILED DESCRIPTION OF THE PREFERRED EMBODIMENT

The present invention provides a system and method for synchronizing computer data such that work can be conducted from a remote location. In the detailed description that follows, like element numerals are used to describe like elements illustrated in one or more figures.

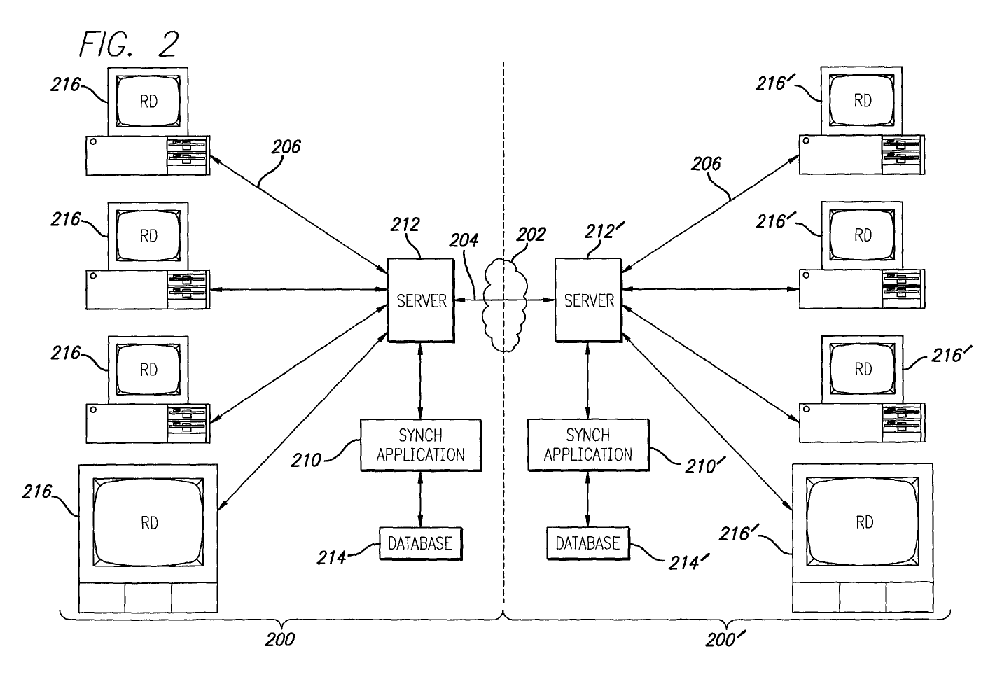

Preferred embodiments of the computer data synchronization system of the present invention operate in accordance with a database, a server, a plurality of reception devices, and a synch application adapted to receive and provide data to the plurality of reception devices. FIG. 2 depicts a physical layer of the computer data synchronization system 200 of the present invention. The computer data synchronization system 200 includes a database 214, a synch application 210, and a server 212 adapted to communicate with a plurality of reception devices (e.g., 216, 216′) via a local area network 206 and a wide area network 204 (such as the internet 202). It should be appreciated that although the computer data synchronization system 200 is shown communicating with a plurality of reception devices (e.g., 216, 216′) directly through a local area network 206, and indirectly through a second synchronization system 200′ (which further includes a database 214′, a synch application 210′, and a server 212′), other combinations of communicating with the plurality of reception devices (e.g., 216, 216′) are within the spirit and scope of this invention. For example, a synchronization system 200 may synchronize a plurality of reception devices (e.g., 216, 216′) solely through a local area network 206, solely through a wide area network 204 (such at the Internet 202), or through a combination of the two. As well, a plurality of reception devices (e.g., 216, 216′) may be synchronized through a single synchronization system 200 (operating alone or in conjunction with other servers 212′) or through a plurality of synchronization systems (e.g., 200, 200′) linked together. It should further be appreciated that the depiction of the local area network 206 and the wide area network 204 is not intended to limited the networking technology of the present invention, but merely to provide an illustrative example of how the present invention may operate. Thus, all hardwired and wireless networking technologies generally known to those skilled in the art are within the spirit and scope of this invention.

The synch application 210 is adapted to receive data from at least one of the plurality of reception devices 216, provide data to the plurality of reception devices 216, and store data within the database 214 (not necessarily in that order). It should be appreciated that the synch application 210 may include one or more computer programs operating on one or more of the plurality of reception devices 216 or on a remote computing device (not shown) adapted to communicate with the plurality of reception devices through the server 212. It should further be appreciated that the databases (e.g., 214, 214′) may reside within at least one data storage device (located in one or more of the plurality of reception devices 216 or in the remote computing device), wherein the at least one data storage device includes, but is not limited to, RAM, cache memory, flash memory, magnetic disks, optical disks, removable disks, SCSI disks, IDE hard drives, tape drives, smart cards, and all other types of data storage devices (and combinations thereof, such as RAID devices) generally known to those skilled in the art. It should also be appreciated that the reception devices (e.g., 216, 216′) include, but are not limited to, personal computers, video conferencing systems, telephones, fax machines, printers, televisions, personal digital assistances (PDAs), mobile phones, and other hardwired and wirelessly connected reception devices generally known to those skilled in the art.

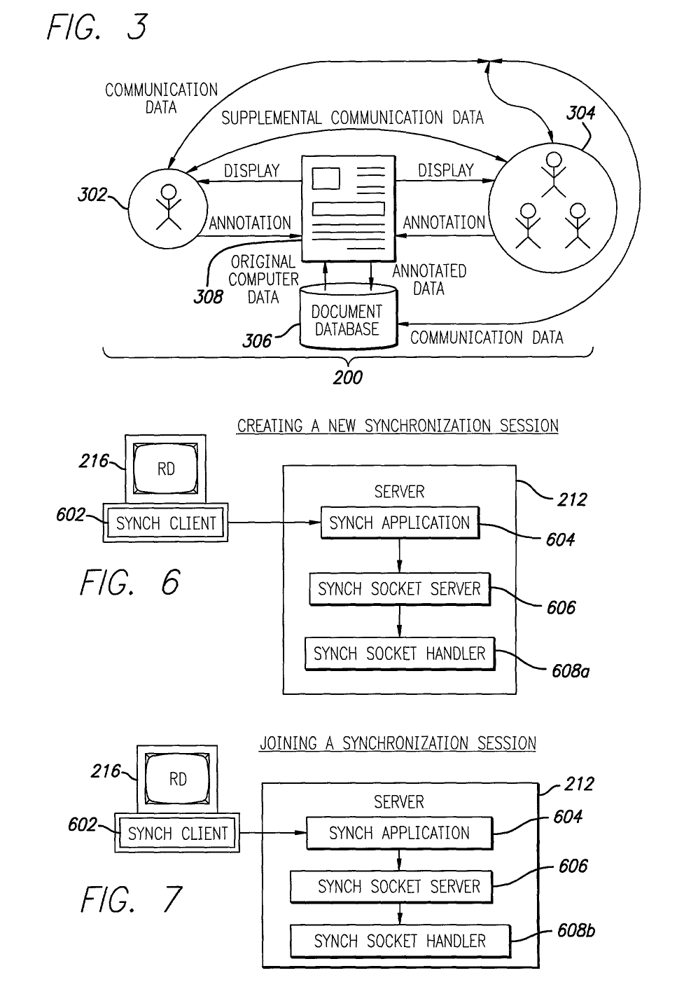

The nature of the communication between the plurality of reception devices 216 is perhaps best understood by viewing the physical layer of the computer data synchronization system 200 (as shown in FIG. 2) together with a communication layer of the computer data synchronization system 200 (as shown in FIG. 3). FIG. 3 shows a primary user 302 communicating with a group of secondary users 304, where the primary user 302 and the secondary users 304 are communicating via the plurality of reception devices 216 depicted in FIG. 2. Once a synchronization session is formed (discussed below), the synch application 210 provides the users 302, 304 with predefined original computer data 308 from a document database 306. The original computer data 308 contained within the document database 306 may include, but is not limited to, textual data, graphical data (e.g., Web pages), application program data, audio data, and video data. It should further be appreciated that the original computer data 308 may originate from, but is not limited to, the database 214, the Internet 202, or one of the plurality of reception devices 216. Because the original computer data 308 may be too large to be displayed on the plurality of reception devices 216 at one time, the synch application 210 receives synchronization data (not shown) from a controlling one of the plurality of reception devices 216 (hereafter referred to as the controlling reception device 216). This synchronization data enables the synch application 210 to provide a portion of the original computer data 308 to the plurality of reception devices 216, such that each reception device 216 displays substantially the same portion of the original computer data 308. If the controlling reception device 216 scrolls down to view a new portion of the original computer data 308, then the synch application 210 responds accordingly by enabling each reception device 216 to display a similar new portion of the original computer data 308. The synchronization data may further enable the synch application 210 to provide pointer icon data (not shown) to the plurality of reception devices 216, where the pointer icon data is related to the controlling reception device's pointer icon and its movement over the top of the original computer data 308. By using such a synchronization system 200, a plurality of remote users 302, 304 can view synchronized original computer data 308 on a plurality of reception devices 216 as if they were viewing original computer data on a single reception device 216 during an in-person meeting.

The synch application 210 may further be adapted to receive annotated data (see FIG. 3) from the controlling reception device 216. The synch application 210 (or a similar application operating on the plurality of reception devices 216) provides the controlling reception device 216 with a toolbar (not shown). This toolbar allows a user (e.g., 302, 304) on the controlling reception device 216 to create, edit, or delete annotated data. This annotated data may include, but is not limited to, text data (e.g., typed, printed, handwritten, or voice recognized text), graphic data (e.g., boxes, lines, circles, and the like), application program data, hyperlink data, video data, and audio data. For example, by interfacing with the provided toolbar, an interacting user (e.g., 302, 304) can add textual data and graphical images on top of the original computer data 308. This annotated data is not only displayed on the controlling reception device 216, but it is also received by the synch application 210 as object data, so that it can be displayed on the non-controlling ones of the plurality of reception devices 216 (hereafter referred to as the non-controlling reception devices 216). The annotated data is dynamically superimposed over the original computer data so that each synchronized reception device 216 sees the annotations at substantially the same time as they are being created.

To overcome the language barrier that may exist with textual and audio annotated data, the synch application 210 (or a similar application operating on the plurality of reception devices 216) may further include a language translation application (not shown) adapted to translate textual and audio annotated data into a least one other textual, graphical, or audio language. For example, if a controlling reception device 216 located in the U.S.A. was synchronized with a reception device 216 located in France, the language translation application may be used to translate an English word or phrase into a corresponding French word or phrase. If multiple English (or French) words or phrases could be used to make the same point (i.e., the point that would be made if the original English (or French) word or phrase was used), then the language translation application may allow the controlling reception device to select a more suitable English (or French) word or phrase (i.e., similar to a thesaurus).

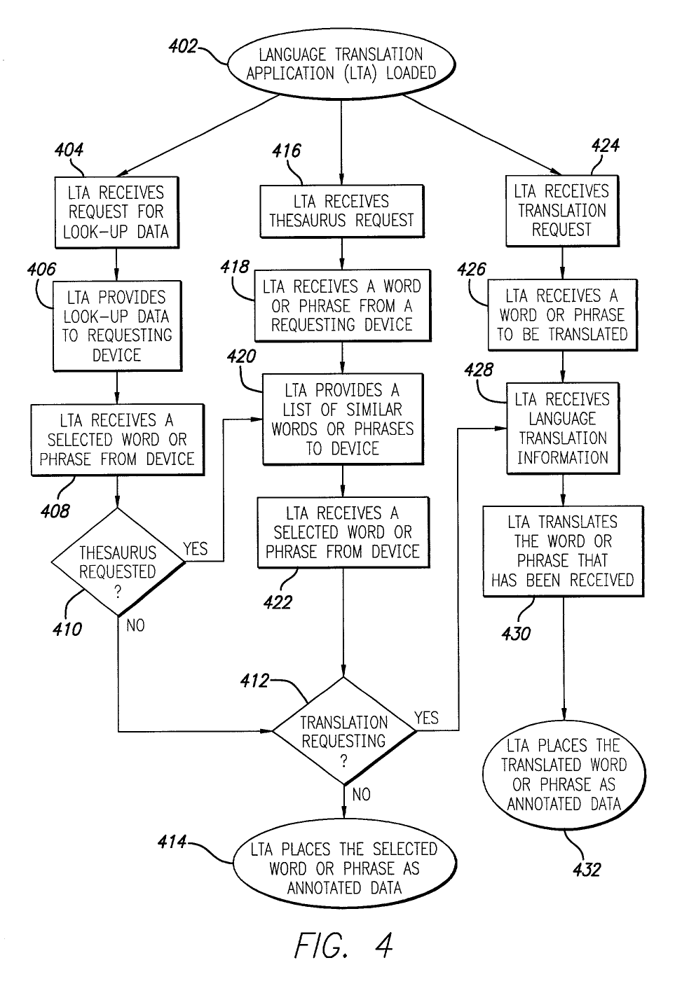

A flow chart pertaining to one embodiment of the language translation application is shown in FIG. 4. Once the language translation application (LTA) has been loaded (or initialized) at step 402, the LTA may be adapted to provide a variety of services. One of those services may be to translate a word or phrase (e.g., textual annotated data) into at least one other foreign language. The LTA acknowledges such a translation request at step 424. The LTA then waits (or prompts the user) for a word or phrase that is to be translated. Once this word or phrase has been received at step 426, the LTA acquires, at step 428, language translation information (LTI), where the LTI is used to identify the translating language(s). It should be appreciated that the LTI received at step 428 may be received in a variety of ways, including, but not limited to, requesting the LTI from the controlling reception device, requesting the LTI from a non-controlling reception device, requesting the LTI from a reception device upon joining a synchronization session, or detecting electronically the location of the plurality of synchronized reception devices. At step 430, the LTA translates the word or phrase in accordance with the LTI. The LTA (or the synch application) then places the translated word or phrase (i.e., the translated annotated data) over the original computer data at step 432, where the placement is consistent with the controlling reception device's instructions (which may be received at any time). It should be appreciated that each synchronized reception device may receive the original annotated data and/or the translated annotated data. Thus, the reception device 216 located in France may receive the translated annotated data, where a reception device 216 located in the U.S.A. may receive the translated annotated data and/or the original annotated data.

The LTA may further provide a service similar to a thesaurus. The LTA acknowledges such a request (i.e., for a thesaurus) at step 416. The LTA then waits (or prompts the user) for a word or phrase that is to be looked-up in a thesaurus database. Once this word or phrase has been received at step 418, the LTA provides the interacting user with a list of similar words or phrases at step 420. The LTA then waits (or prompts the user) for a selection from the provided list. Once a selected word or phrase has been received at step 422, the LTA determines whether the interacting user would like the selected word translated at step 412. If the answer is YES, then the LTA acquires the LTI at step 428, where the translation process is carried out as previously discussed. If the answer is NO, then the LTA places the selected word or phrase (i.e., annotated data) over the original computer data at step 414, where the placement is consistent with the controlling reception device's instructions (which may be received at any time).

The LTA may also allow an interacting user to look up a word or phrase that is acknowledged by the LTA in look-up data, such as a database or a directory. The LTA acknowledges a request for look-up data at step 404. The LTA then provides the interacting user with the look-up data (or a designated portion thereof) at step 406, where the look-up data contains a list of words or phrases acknowledged by the LTA. The LTA then waits (or prompts the user) for a selection from the look-up data. Once the selected word or phrase has been received at step 408, the LTA determines whether the user would like thesaurus information on the selected word or phrase at step 410. If the answer is YES, then the user is provided a list of similar words or phrases at step 420, where the thesaurus process is carried out as previously discussed. If the answer if NO, then the LTA determines whether the user would like the selected word or phrase translated at step 412. If the answer is YES, then the LTA acquires the LTI at step 428, where the translation process is carried out as previously discussed. If the answer is NO, then the LTA places the selected word or phrase (i.e., annotated data) over the original computer data at step 414, where the placement is consistent with the controlling reception device's instructions (which may be received at any time).

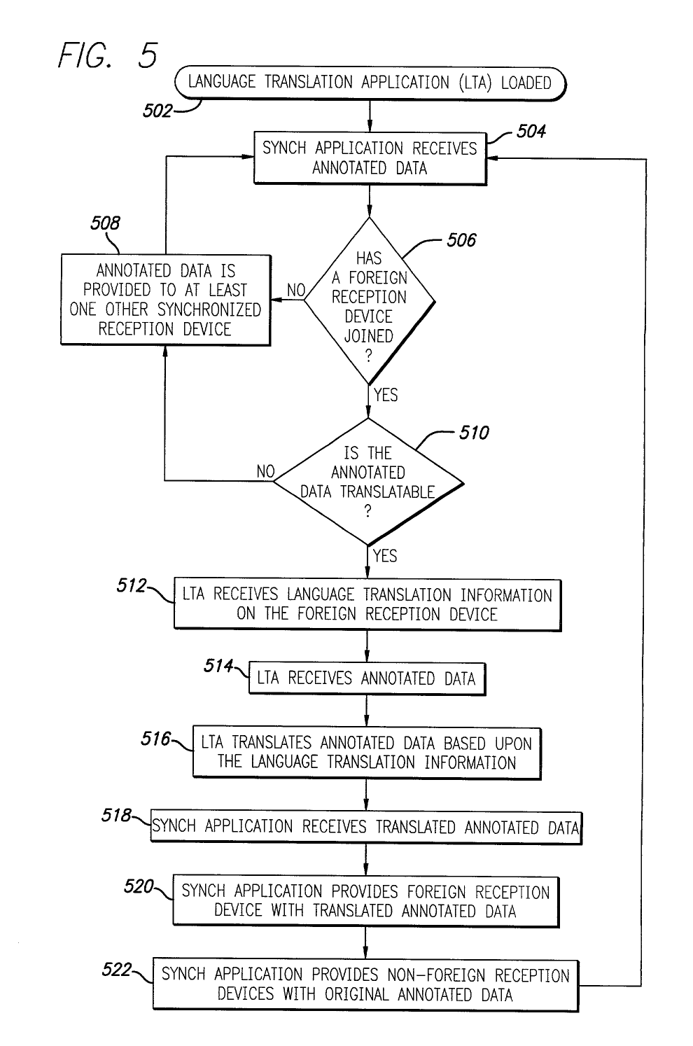

A flow chart pertaining to another embodiment of the language translation application is shown in FIG. 5. At step 502, the language translation application (LTA) is loaded or initialized. The synch application then receives annotated data from a controlling reception device at step 504. Once annotated data has been received, the synch application (or the LTA) determines whether a foreign reception device (i.e., requiring translated data) has joined the synchronization session at step 506. If the answer is NO, then the annotated data is provided (un-translated) to at least one other synchronized reception device at step 508. If the answer is YES, then the synch application (or the LTA) determines whether the annotated data is of the type that is translatable (i.e., textual annotated data). If the answer is NO, then the annotated data is provided (un-translated) to at least one other synchronized reception device at step 508. If the answer is YES, then the LTA acquires, at step 512, language translation information (LTI), where the LTI is used to identify the translating language(s). It should be appreciated that the LTI received at step 512 may be received in a variety of ways, including, but not limited to, requesting the LTI from the controlling reception device, requesting the LTI from a non-controlling reception device, requesting the LTI from a reception device upon joining a synchronization session, or detecting electronically the location of the plurality of synchronized reception devices. The LTA then receives the annotated data at step 514. At step 516, the LTA translates the annotated data in accordance with the LTI. The synch application then receives the translated annotated data at step 518. The synch application can then provide the foreign reception device with the translated annotated data at step 520, and provide any non-foreign reception devices with the original annotated data at step 522.

It should be appreciated that other combinations of distributing the original annotated data and/or the translated annotated date are within the spirit and scope of this invention. It should further be appreciated that the LTA may be used at any time to translate previously provided annotated data. Thus, the LTA can translate textual annotation data (e.g., typed, printed, handwritten, or voice recognized text) or audio annotated data immediately after it has been received, when a foreign reception device joins the synchronization session, or when a foreign reception device requests to view a previous synchronization session (or previously stored original computer data with annotations). It should be appreciated that the flow charts of FIGS. 4 and 5 are not intended to limit the language translation application of the present invention. Other language translation applications that contain a different number of steps, a different sequence of steps, or combine with at least one other application (e.g., the synch application) to perform such steps, are within the spirit and scope of this invention.

To further facilitate communication between the plurality of reception devices 216, the synch application 210 may receive (or create) additional annotated data including user identification data. For example, after the controlling reception device 216 has created annotated data, the controlling reception device 216 (or the synch application 210) may further create additional annotated data such as user identification data, where the user identification data may include, but is not limited to, the user's name (or other identifying information) and the date the annotated data was created. This additional annotated data (i.e., user identification data) may be superimposed over the original computer data near the corresponding annotated data to provide the plurality of reception devices 216 with additional information pertaining to the annotations. It should be appreciated that other forms of displaying the additional annotated data to a user, such as saving it as part of the corresponding annotated data's meta-data or providing it to a user upon interaction with the corresponding annotated data, is within the spirit and scope of this invention. The annotated data and the additional annotated data (hereafter collectively referred to as annotated data) are then stored in the document database 306 (e.g., the database 214) along with corresponding data (not shown) that links the annotated data to a portion of the original computer data 308. This corresponding data allows the annotated data to be retrieved and viewed (or heard) in its original context at a later time.

To enable the annotated data to be viewed in its original context at a later time, the synch application (or a similar application operating on the plurality of reception devices) may further include a locking application (not shown) adapted to lock the annotated data to a portion of the original computer data. More particularly, the locking application is adapted to objectify the images contained within the original computer data and retrieve (or create) a list of image parameters (e.g., shape, size, location, etc.) associated with each image. The locking application is further adapted to objectify the annotated data (unless it has already been objectified by the synch application 210) and retrieve (or create) a list of annotated parameters associated with each annotated data. The annotated parameters may include, but are not limited to, images that are intersected by the annotated data, images that surround the annotated data, and images that are in close proximity with the annotated data. By using the objectified information, the image parameters, and the annotated parameters, the annotated data can be viewed in its original context at a later time regardless of the browser application that is being used or the size and shape of the browser window.

The synch application (or a similar application operating on the plurality of reception devices 216) may further provide the plurality of reception devices with a synch button (not shown). By interacting with the synch button, any one of the plurality of reception devices 216 can become the controlling reception device 216, and thus provide synchronization data and annotated data (or edit and delete annotated data) to the synch application 210. This allows each reception device 216 to participate in the synchronization session in an orderly fashion.

The synch application 210 may further be adapted to receive communication data (see FIG. 3) from at least one of the plurality of reception devices 216. To display a displayable portion of the communication data, the synch application 210 (or a similar application operating on the plurality of reception devices 216) may further be adapted to provide the plurality of reception devices 216 with at least one communication window (not shown), which may include, but is not limited to a text window, a video window, or a graphic window. These communication windows (along with audio devices) allow the users 302, 304 to create and display communication data that includes, but is not limited to, text data, graphic data, program application data, hyperlink data, video data, and audio data. For example, by interfacing with a provided text window, an interacting user (e.g., 302, 304) can create textual messages while the original computer data 308 is being displayed. These messages are not only displayed in the interactive user's text window, but are also received by the synch application 210, so that they can be displayed in the plurality of text windows available to the other synchronized users (e.g., 302, 304). The communication data (e.g., textual messages) are then stored in the document database 306 (e.g., the database 214) along with corresponding data (not shown) that links the communication data to the original computer data 308. This corresponding data allows the communication data to be retrieved and viewed (or heard) in its original context at a later time. It should be appreciated that the language translation application, as discussed above, can also be used to translate or convert textual messages into another textual or graphical language or expression. The primary difference between the annotated data and the communication data is that the communication data can be provided by any one of the plurality of reception devices 216 (not just the controlling reception device 216).

The computer data synchronization system 200 may further operate in conjunction with supplemental communication data (see FIG. 3). Supplemental communication data is data that is not transmitted through the synch application 210, but is instead transmitted through a communication channel (e.g., telephone lines, cable lines, or wireless signals) directly to the plurality of reception devices 216. Thus, the supplemental communication data is typically transmitted via a transmission protocol that is different from the TCP/IP protocol most commonly used to transmit data over networks such as the Internet. This supplemental communication data may include, but is not limited to, text data, graphic data, audio data, and video data. For example, an interactive user can supplement the original computer data, the annotated data, and the communication data by transmitting video and audio signals over telephone lines directly to the plurality of reception devices 216. Although FIG. 3 does not show the supplemental communication data being saved in the document database 306, it should be appreciated that the synch application 210 (or a similar application operating the plurality of reception devices) may be adapted to store the supplemental communication data, such that it can be retrieved and viewed (or heard) in its original context at a later time. By synchronizing all four forms of data (i.e., original computer data, annotated data, communication data, and supplemental communication data), in-person meetings can be simulated (and replayed) between users thousands of miles apart.

FIG. 6 shows how a first reception device 216 interfaces with the server 212 to create a new synchronization session. The first reception device 216 further includes a synch client 602 for interfacing with the server 212. More particularly, the synch client 602 sends initiation data to a synch application 604 operating on the server 212. The synch application 604 uses the initiation data to create a synch socket server 606, which defines the synchronization session by receiving data from, and providing data to a plurality of reception devices 216. The synch socket server 606 creates a first synch socket handler 608a for interfacing directly with the first reception device 216.

FIG. 7 shows how a second reception device 216 interfaces with the server 212 to join an existing synchronization session. The second reception device 216, which also includes a synch client 602, sends joiner data to the synch application 604. The synch application 604 uses the joiner data to join the second reception device 216 to the first reception device through the synch socket server 606. The synch socket server 606 creates a second synch socket handler 608b for interfacing directly with the second reception device 216. Subsequent reception devices 216 can join the existing synchronization session in the same manner as the second reception device 216.

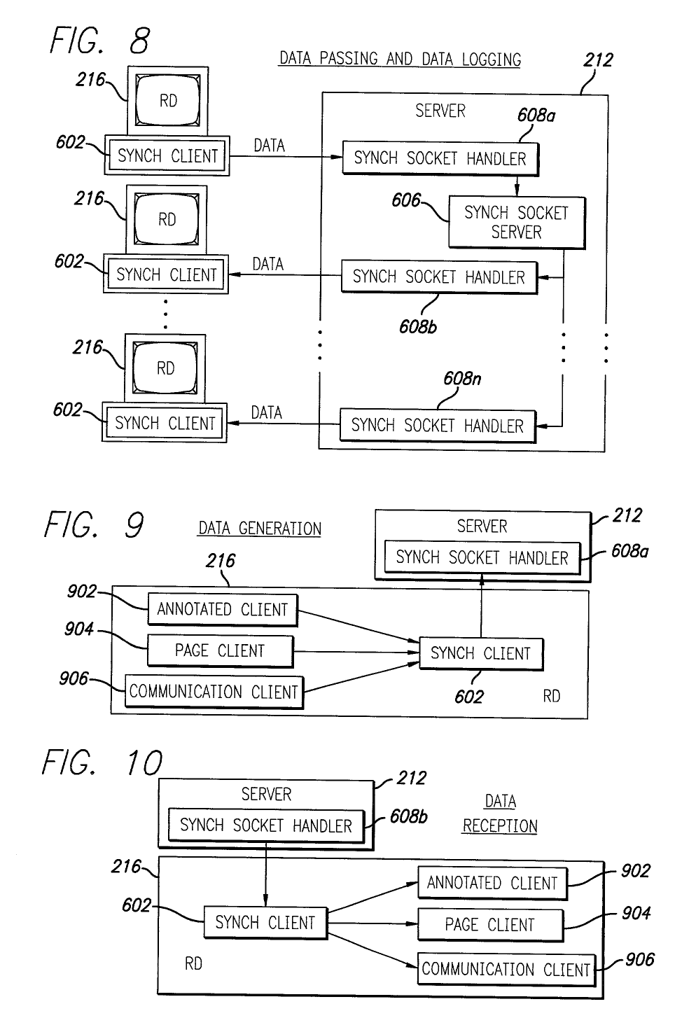

FIG. 8 shows a plurality of reception devices 216 synchronized through a server 212 such that each reception device 216 displays substantially the same data. The synch socket server 606 is adapted to receive synchronization data, annotated data, and message data from at least one of the plurality of reception devices 216. Once the synch socket server 606 receives this data, the data is logged (for linking purposes), and then provided to the plurality of reception devices 216. For example, the synch client 602 operating on a first reception device 216 may provide data to a corresponding synch socket handler 608a operating on the server 212. The corresponding synch socket handler 608a then provides the data to the synch socket server 606, where the data is logged and passed on to all other synch socket handlers 608b, 608n previously created by the synch socket server 606. These synch socket handlers 608b, 608n then provide the data to the corresponding synch clients 602 operating on the plurality of reception devices 216.

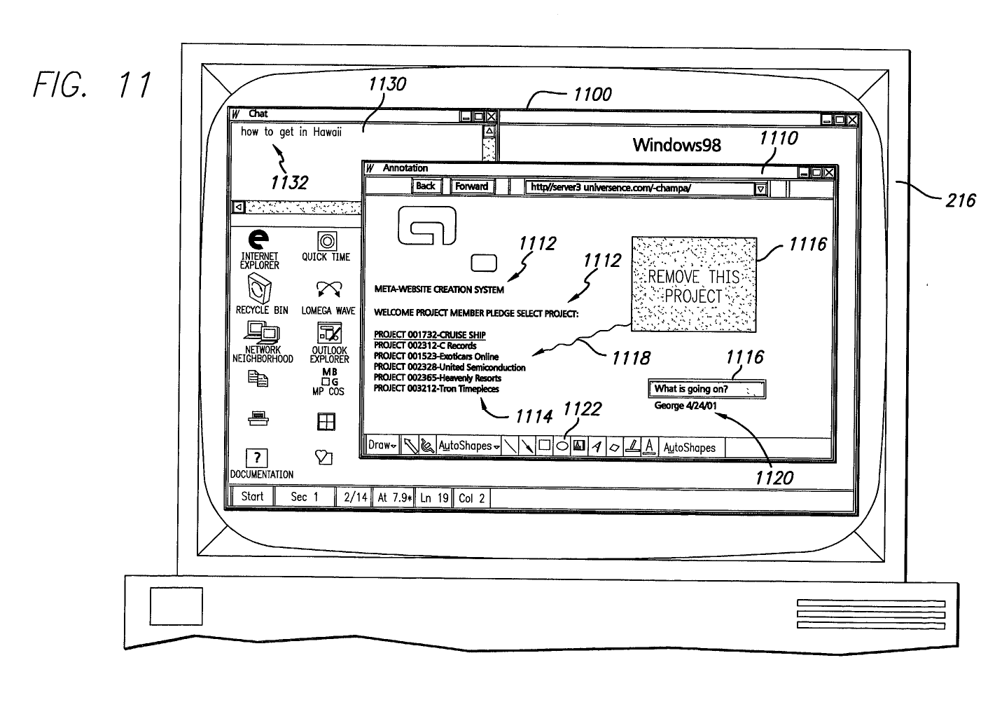

FIGS. 9 and 10 show how each reception device 216 may further include an annotated client 902, a page client 904, and a communication client 906. A controlling reception device 216 may use the page client 904 and the annotated client 902 to send synchronization data and annotated data, respectively, to the synch socket server 606. As mentioned above, this data is then used to synchronize the plurality of reception devices 216 such that each reception device 216 displays similar annotated data superimposed over a similar portion of original computer data. The communication client 906 is used by the plurality of reception devices 216 to send and receive communication data, which is displayed in a communication window.

FIG. 11 shows a reception device 216 including a desktop 1100, a communication window 1130, and a browser client 1110 operating in accordance with the computer data synchronization system 200 of the present invention. The communication window 1130 further includes communication data 1132, and the browser client 1110 further includes a portion of original computer data 1112, 1114 and annotated data 1116, 1118, 1120. As discussed above, the annotated data 1116, 1118, 1120 and the communication data 1132 are generated during a synchronization session between the reception device 216 and at least one other reception device (not shown). A controlling one of the plurality of reception devices (e.g., the reception device 216) can use the toolbar 1122 to add annotated data 1116, 1118, 1120 over a portion of original computer data or delete/edit annotated data 1116, 1118, 1120 that already exists over a portion of the original computer data. The annotated data 1116, 1118, 1120 may include textual annotated data 1116, graphical annotated data 1118, and additional annotated data 1120 (i.e., user identification data, which may also be created by the synch application 210). It should be appreciated that any one of these annotations (i.e., annotated data 1116, 1118, 1120) may further contain hyperlink data such that an interacting user can interact with the annotation (i.e., annotated data 1116, 1118, 1120) containing the hyperlink data to receive additional original computer data (e.g., textual data, graphical data (e.g., Web page data), program application data, video data, audio data, etc). To further enable communication between the plurality of reception devices, any one of the plurality of reception devices (e.g., the reception device 216) can send communication data 1132 (such as text data (e.g., chat messages)) such that it can be displayed in a communication window 1130 (such as a text window (e.g., chat room)). By using the computer data synchronization system 200, a plurality of users can participate in an in-person meeting regardless of the distance between the plurality of users.

Having thus described a system and method for synchronizing computer data, it should be apparent to those skilled in the art that certain advantages of the system have been achieved. It should also be appreciated that various modifications, adaptations, and alternative embodiments thereof may be made within the scope and spirit of the present invention. Although the invention as described overcomes specific dilemmas alluded to in the description of the related art (i.e., communication problems within service-based industries), it should be appreciated that this invention may also be used to enhance communication within other industries, such as, but not limited to, Website production, animation production, consultation, software development, customer support, professional services (e.g., legal, medical, etc.), and entertainment services (e.g., games, entertainment media, etc.).

For example, industries such as Website production, animation production, and software development typically require a great deal of communication between the company, partnerships, subcontractors, and foreign affiliates and between the company and the client (who may be providing design criteria and making approvals). Through the use of the present invention, these entities can communicate over great distances in a similar manner as if they were in an in-person meeting. Industries such as consultation, customer support, and professional services usually require an extreme amount of interaction between the company and the client (who is usually requesting some sort of aid or help). By using the present invention to simulate an in-person meeting, the client can provide the company with original computer data (e.g., such as video and text data) that fully depicts the client's dilemma (e.g., an inoperable computing device, an infected laceration, etc.). The company can then provide annotated data (e.g., marking up the client's video data) and communication data (e.g., additional video, audio, or textual data) to the client in order to further clarify the dilemma and/or provide detailed instructions on how to solve the dilemma. Industries such as entertainment services may require the collaboration of multiple users (e.g., on-line videogame participants) or may run more efficiently by collaborating multiple users (e.g., steaming video to a plurality of recipients). The present invention enables these users to communication with one another (e.g., pointing to a particular location on a game board, chat during the presentation of a video, etc.) as if the multiple users were located in the same location (e.g., in the same room). It should be appreciated that these applications of the present invention are merely to illustrate how the invention may be used within a variety of industries, and are not intended to further limit the invention. Use of this invention in additional industries and in additional manners are within the spirit and scope of this invention. The invention is further defined by the following claims.

What is claimed is:

1. A computer data synchronization system comprising:
a database for storing original computer data;
a server adapted to communicate with a plurality of reception devices; and
a synch application connected to said database, wherein said synch application is adapted to receive synchronization data from a controlling one of said plurality of reception devices, said synch application is further adapted to provide a portion of said original computer data to said plurality of reception devices, wherein said portion of said original computer data is based upon a synchronized portion of said original computer data that is being displayed on said controlling one of said plurality of reception devices.

2. The synchronization system of claim 1, wherein said synchronization data further comprises pointer icon data, wherein said pointer icon data corresponds to a movable pointer icon operating on said controlling one of said plurality of reception devices.

3. The synchronization system of claim 2, wherein said synch application is further adapted to provide said synchronization data to at least one other one of said plurality of reception devices such that said movable pointer icon is superimposed over said portion of said original computer data.

4. The synchronization system of claim 1, wherein said synch application is further adapted to provide said plurality of reception devices with a synch button, wherein said synch button is adapted to enable a non-controlling one of said plurality of reception devices to become said controlling one of said plurality of reception devices.

5. The synchronization system of claim 1, wherein said synch application is further adapted to receive annotated data from said controlling one of said plurality of reception devices, wherein said annotated data corresponds to said portion of said original computer data.

6. The synchronization system of claim 5, wherein said annotated data is selected from a group of annotated data consisting of text, graphic, program application, hyperlink, audio, and video.

7. The synchronization system of claim 5, wherein said synch application is further adapted to provide said controlling one of said plurality of reception devices with a toolbar, wherein said toolbar is adapted to enable said controlling one of said plurality of reception devices to create, edit, and delete said annotated data.

8. The synchronization system of claim 5, wherein said synch application is further adapted to provide said annotated data to at least one other one of said plurality of reception devices such that said annotated data is superimposed over said portion of said original computer data.

9. The synchronization system of claim 8, wherein said synch application further comprises a language translation application adapted to translate said annotated data into at least one other language.

10. The synchronization system of claim 9, wherein said language translation application is further adapted to provide thesaurus information to said controlling one of said plurality of reception devices.

11. The synchronization system of claim 8, wherein said synch application is further adapted to provide additional annotated data to said at least one other one of said plurality of reception devices, wherein said additional annotated data corresponds to said annotated data and comprises user identification data.

12. The synchronization system of claim 8, wherein said annotated data and correspondence data linking said annotated data to said portion of said original computer data is stored in said database such that said annotated data and said portion of said original computer data can be replayed at a later time.

13. The synchronization system of claim 12, wherein said synch application further comprises a language translation application adapted to translate said annotated data at approximately the same time said annotated data and said portion of said original computer data are replayed.

14. The synchronization system of claim 1, wherein said synch application is further adapted to receive communication data from at least one of said plurality of reception devices after said portion of said original computer data has been provided to said plurality of reception devices.

15. The synchronization system of claim 14, wherein said communication data is selected from a group of communication data consisting of text, graphics, program application, hyperlink, audio, and video.

16. The synchronization system of claim 14, wherein said synch application is further adapted to provide said communication data to at least one other one of said plurality of reception devices such that said communication data is displayed in a communication window.

17. The synchronization system of claim 16, wherein said synch application further comprises a language translation application adapted to translate said communication data into at least one other language.

18. The synchronization system of claim 14, wherein said communication data and correspondence data linking said communication data to said portion of said original computer data is stored in said database such that said communication data and said portion of said original computer data can be replayed at a later time.

19. The synchronization system of claim 18, wherein said synch application further comprises a language translation application adapted to translate said communication data at approximately the same time said communication data and said portion of said original computer data are replayed.

20. The synchronization system of claim 8, wherein said synch application further comprises a locking application adapted to link said annotated data to at least one object contained within said portion of said original computer data.

21. The synchronization system of claim 20, wherein said locking application is further adapted to perform the functions of:
objectify at least one image contained within said portion of said original computer data;
create a set of image parameters corresponding to each one of said at least one image;
objectify said annotated data; and
create a set of annotated parameters corresponding to said annotated data.

22. The synchronization system of claim 21, wherein said annotated parameters include intersecting image data, surrounding image data, and close-proximity image data.

23. A method for synchronizing computer data comprising the steps of:
identifying a plurality of reception devices requesting a synchronization session;
receiving synchronization data from a controlling one of said plurality of reception devices; and
providing a portion of original computer data to said plurality of reception devices, wherein said portion of original computer data is based upon a synchronized portion of said original computer data that is being displayed on said controlling one of said plurality of reception devices.

24. The method of claim 23, wherein said step of identifying a plurality of reception devices further comprises receiving session initiation data from a first one of said plurality of reception devices.

25. The method of claim 24, wherein said step of identifying a plurality of reception devices further comprises receiving session joiner data from a second one of said plurality of reception devices.

26. The method of claim 23, wherein said step of receiving synchronization data further comprises receiving pointer icon data, wherein said pointer icon data corresponds to a movable pointer icon operating on said controlling one of said plurality of reception devices.

27. The method of claim 26, wherein said step of providing said portion of said original computer data further comprises providing said synchronization data to at least one other one of said plurality of reception devices such that said movable pointer icon is superimposed over said original computer data.

28. The method of claim 23, wherein said step of receiving synchronization data further comprises receiving synch button data from a non-controlling one of said plurality or reception devices, wherein said synch button data is adapted to enable a non-controlling one of said plurality of reception devices to become said controlling one of said plurality of reception devices.

29. The method of claim 23, wherein said step of receiving synchronization data further comprises receiving annotated data from said controlling one of said plurality of reception devices, wherein said annotated data corresponds to said portion of said original computer data.

30. The method of claim 29, wherein said step of receiving annotated data further comprises selecting said annotated data from a group of annotated data consisting of text, graphics, program application, hyperlink, audio, and video.

31. The method of claim 29, wherein said step of providing said portion of original computer data further comprises providing a toolbar adapted to enable said controlling one of said plurality of reception devices to create, edit, and delete said annotated data.

32. The method of claim 29, wherein said step of providing said portion of original computer data further comprises providing said annotated data to at least one other one of said plurality of reception devices such that said annotated data is superimposed over said portion of said original computer data.

33. The method of claim 32, further comprising the step of translating said annotated data into at least one other language before said annotated data is provided to said at least one other one of said plurality of reception devices.

34. The method of claim 33, wherein said step of providing said annotated data further comprises providing additional annotated data to said at least one other one of said plurality of reception devices, wherein said additional annotated corresponds to said annotated data and comprises user identification data.

35. The method of claim 29, further comprising the step of storing said annotated data and correspondence data linking said annotated data to said portion of original computer data such that said annotated data and said portion of original computer data can be replayed at a later time.

36. The method of claim 29, further comprising the step of translating said annotated into at least one other language at approximately the same time said annotated data and said portion of original computer data are replayed.

37. The method of claim 23, wherein said step of receiving synchronization data further comprises receiving communication data from at least one of said plurality of reception devices after said portion of original computer data has been provided to said plurality of reception devices.

38. The method of claim 37, wherein said step of receiving communication data further comprises selecting said communication data from a group of communication data consisting of text, graphics, program application, hyperlink, audio, and video.

39. The method of claim 37, wherein said step of providing said original computer data further comprises providing said communication data to at least one other one of said plurality of reception devices such that said communication data is displayed in a communication window.

40. The method of claim 37, further comprising the step of storing said communication data and correspondence data linking said communication data to said portion of original computer data such that said communication data and said portion of original computer data can be replayed at a later time.

41. The method of claim 23, wherein said step of receiving synchronization data further comprises receiving supplemental communication data from at least one of said plurality of reception devices, wherein said supplemental communication data is transmitted via a transmission protocol that is different from the TCP/IP Internet protocol used to transmit data over the Internet.

42. The method of claim 41, wherein said step of providing said original computer data further comprises providing said supplemental communication data to at least one other one of said plurality of reception devices.

43. The method of claim 41, further comprising the step of storing said supplemental communication data and correspondence data linking said supplemental communication data to said original computer data such that said supplemental communication data and said original computer data can be replayed at a later time.

44. The method of claim 29, further comprising the steps of:
objectifying at least one image contained within said original computer data;
creating a set of image parameters corresponding to each one of said at least one image;
objectifying said annotated data; and
creating a set of annotated parameters corresponding to said annotated data.

45. The method of claim 44, wherein said annotated parameters include intersecting image data, surrounding image data, and close-proximity image data.
